(19) United States
(12) Patent Application Publication
(10) Pub. No.: US 2009/0273707 A1
(43) Pub. Date: Nov. 5, 2009

(54) FRAME RATE CONVERSION APPARATUS, FRAME RATE CONVERSION METHOD, AND COMPUTER-READABLE STORAGE MEDIUM

(75) Inventor: Ai Miyoshi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/423,342

(22) Filed: Apr. 14, 2009

(30) Foreign Application Priority Data
May 1, 2008 (JP) 2008-119988

(51) Int. Cl. H04N 7/01

(52) U.S. Cl. 348/441; 348/E07.003

(57) ABSTRACT

A frame rate conversion apparatus for performing frame rate conversion upon distributing an input-frame into a plurality of sub-frames detects the degree of motion of each region including one pixel or a plurality of pixels in the input-frame, determines the amount of distribution of an output value in each region in the plurality of sub-frames in accordance with the detected degree of motion of each region, and outputs the plurality of sub-frames to which output values are distributed in accordance with the determined amounts of distribution.

### BACKGROUND OF THE INVENTION

1. Field of the Invention

The present invention relates to a frame rate conversion apparatus, frame rate conversion method, and computer-readable storage medium which convert the frame rate of an input image (input-frame).

2. Description of the Related Art

Display apparatuses are roughly classified according to their display characteristics into either impulse type or hold type. An apparatus such as a liquid crystal panel which holds display almost uniformly during one frame period as shown in FIG. 14B will be referred to as a hold type display apparatus. In contrast, an apparatus with a short period of light emission in one frame as shown in FIG. 14A will be referred to as an impulse type display apparatus.

Impulse type display apparatuses include a CRT (Cathode Ray Tube) and a field emission type display. In impulse type display, pixels repeatedly blink, and hence the display has a characteristic that causes flicker. That is, the screen appears to flicker. A higher luminosity and larger area correspond to easier flicker detection. With the recent tendency toward larger display screens, flicker on impulse type display apparatuses is increasingly becoming a problem to be solved.

Methods of reducing flicker include a method of displaying an image at a higher frame rate by distributing an input-frame into a plurality of sub-frames at an arbitrary ratio. If, for example, the frame rate is doubled by distributing an input-frame into two sub-frames at a ratio of 6:4, since the frequency of flickering increases, flicker becomes difficult to detect.

However, when a user views this display, as shown in FIG. 15, pseudo-contour which depends on a visual characteristic occurs because a temporally succeeding sub-frame can be seen to shift from line-of-sight tracking during a given frame period.

In addition, when a scene with a vigorous motion or the like is displayed, trailing-blur sometimes occurs. As a technique of dealing with such trailing-blur, a technique of attenuating the pixel value of part of a sub-frame in accordance with the motion amount (vector) of the frame is known (Japanese Patent Laid-Open No. 2007-052184). A pixel value is alternately attenuated for each pixel between sub-frames.

According to the technique disclosed in Japanese Patent Laid-Open No. 2007-052184, a pseudo-contour is generated because even in a motion region half the number of luminance-bearing pixels exist in a temporally succeeding output sub-frame. FIG. 16 is a view showing the relationship between an outline of a display output when the technique in Japanese Patent Laid-Open No. 2007-052184 is used and the manner of how the display output is visually perceived. Obviously, the luminance of a sub-frame at an end portion of the motion region is seen as a pseudo-contour.

### SUMMARY OF THE INVENTION

The present invention provides a frame rate conversion apparatus, frame rate conversion method, and computer-readable storage medium which reduce pseudo-contour and image collapse while maintaining the effect of reducing flicker.

According to a first aspect of the present invention, there is provided a frame rate conversion apparatus for performing frame rate conversion upon distributing an input-frame into a plurality of sub-frames, the apparatus comprising: a detection unit configured to detect a degree of motion of each region including at least one pixel in the input-frame; a determination unit configured to determine an amount of distribution of an output value in each region in the plurality of sub-frames in accordance with the degree of motion of each region detected by the detection unit; and an output unit configured to output the plurality of sub-frames to which output values are distributed in accordance with the amount of distribution determined by the determination unit.

According to a second aspect of the present invention, there is provided a frame rate conversion method for performing frame rate conversion upon distributing an input-frame into a plurality of sub-frames, the method comprising: detecting a degree of motion of each region including one pixel or a plurality of pixels in the input-frame; determining an amount of distribution of an output value in each region in the plurality of sub-frames in accordance with the detected degree of motion of each region; and outputting the plurality of sub-frames to which output values are distributed in accordance with the determined amount of distribution.

According to a third aspect of the present invention, there is provided a computer-readable storage medium storing a computer program of causing a computer incorporated in a frame rate conversion apparatus for performing frame rate conversion upon distributing an input-frame into a plurality of sub-frames to function as a detection unit configured to detect a degree of motion of each region including one pixel or a plurality of pixels in the input-frame, a determination unit configured to determine an amount of distribution of an output value in each region in the plurality of sub-frames in accordance with the degree of motion of each region detected by the detection unit, and an output unit configured to output the plurality of sub-frames to which output values are distributed in accordance with the amount of distribution determined by the determination unit.

Further features of the present invention will be apparent from the following description of exemplary embodiments with reference to the attached drawings.

### BRIEF DESCRIPTION OF THE DRAWINGS

FIG. 1 is a block diagram showing an example of the schematic arrangement of a frame rate conversion apparatus according to an embodiment of the present invention;

FIG. 2 is a graph showing an example of an input/output relationship in a distribution processing unit 106 shown in FIG. 1;

FIG. 3 is a flowchart showing an example of processing in a motion region detection unit 103 shown in FIG. 1;

FIG. 4 is a graph showing an example of a method of calculating a degree M of motion in the motion region detection unit 103 shown in FIG. 1;

FIG. 5 is a flowchart showing an example of processing in a distribution correction coefficient generating unit 104 shown in FIG. 1;

FIG. 6 is a view showing an example of an outline of processing in the distribution correction coefficient generating unit 104;

FIG. 7 is a view showing an example of an outline of processing in the distribution correction coefficient generating unit 104 (without execution of comparison reduction filter processing);

FIG. 8 is a view showing an example of an outline of a display output when no comparison reduction filter processing is performed and an outline of the manner of how the display output is visually perceived;

FIGS. 9A to 9C are views each showing an example of an emission luminance;

FIG. 10 is a view showing an example of an outline of a display output in the case shown in FIG. 9C and an example of an outline of the manner of how the display output is visually perceived;

FIG. 11 is a flowchart showing an example of a processing sequence in the frame rate conversion apparatus shown in FIG. 1;

FIG. 12 is a flowchart showing an example of processing in the motion region detection unit 103 according to a modification;

FIG. 13 is a graph showing an example of a method of calculating a degree M of motion in the motion region detection unit 103 according to the modification;

FIGS. 14A and 14B are graphs each showing an example of an emission luminance in a display apparatus;

FIG. 15 is a first view showing an example of an outline of a display output and an example of the manner of how the display output is visually perceived in the prior art; and

FIG. 16 is a second view showing an example of an outline of a display output and an example of the manner of how the display output is visually perceived in the prior art.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### Embodiment

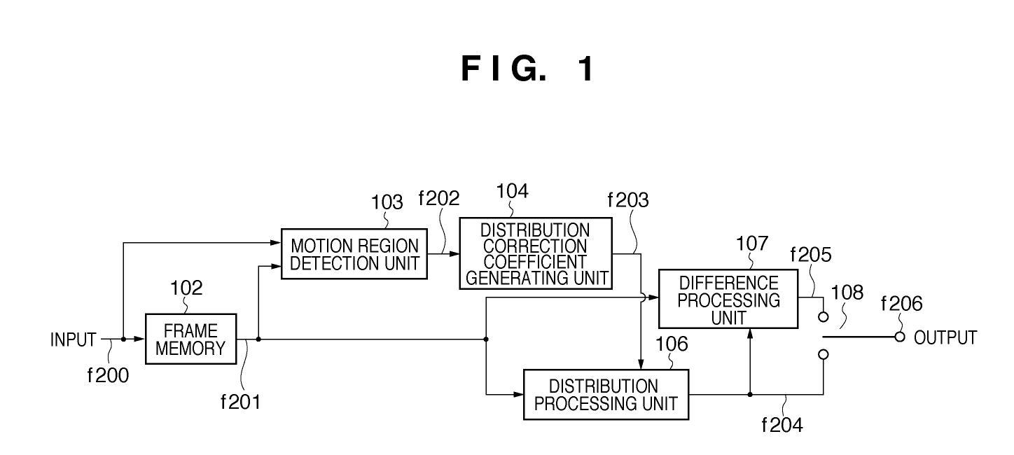

FIG. 1 is a block diagram showing an example of the schematic arrangement of a frame rate conversion apparatus according to an embodiment of the present invention.

The frame rate conversion apparatus incorporates a computer. The computer includes a main control unit such as a CPU and storage units such as a ROM (Read Only Memory) and a RAM (Random Access Memory). The computer may also include, for example, an input/output unit such as a display or a touch panel, and a communication unit such as a network card. Note that these constituent elements are connected via a bus or the like and are controlled by making the main control unit execute the programs stored in the storage unit.

The frame rate conversion apparatus distributes an input image (to be referred to as an input-frame hereinafter) into a plurality of sub-frames and outputs them at a plural (integer) multiple of the frame rate. In distributing an input-frame, the motion of each region in the input-frame is detected from an inter-frame difference, and distribution is performed with the detection result on the motion being reflected in each region in a sub-frame. Note that this embodiment will exemplify a case in which the frame rate of an input-frame is doubled by frame rate conversion.

The frame rate conversion apparatus converts the frame rate of an input-frame to reduce flickering on the screen, that is, the occurrence of flicker. The frequency of occurrence of flicker is associated with the contrast between distributed sub-frames. That is, in the case shown in FIG. 1, the occurrence of flicker is influenced by the contrast relationship between a sub-frame f204 and a sub-frame f205. The larger the luminance difference between them, the more easily flicker is detected, and vice versa. Note that the sub-frame f204 is output as a temporally succeeding sub-frame in one frame period, and the sub-frame f205 is output as a temporally preceding frame in one frame period.

The frame rate conversion apparatus controls the contrast between the sub-frame f204 and the sub-frame f205 for each region in each sub-frame. This control is performed on the basis of the relationship between the motion of each region detected between the respective frames and flicker. The sum of the luminances of the sub-frames f204 and f205 is equal to the luminance of a frame f201 held in a frame memory 102. That is, the luminance remains the same before and after frame rate conversion.

In this case, the frame rate conversion apparatus includes, as its functional constituent elements, a frame memory 102, a motion region detection unit 103, a distribution correction coefficient generating unit 104, a distribution processing unit 106, a difference processing unit 107, and a switch 108.

The frame memory 102 sequentially holds one or more input-frames. The motion region detection unit 103 compares the frame f201 held in the frame memory 102 with an input-frame f200, calculates a degree M of motion of each region in the frame f201 held in the frame memory 102, and outputs a degree-of-motion map Mₘₐₚ.

The distribution correction coefficient generating unit 104 executes filter processing for the degree-of-motion map Mₘₐₚ and outputs the result as a distribution correction coefficient map Rₘₐₚ to the distribution processing unit 106. The distribution processing unit 106 converts the value of the frame f201 held in the frame memory 102 in accordance with a basic distribution function and the distribution correction coefficient map Rₘₐₚ, and outputs the sub-frame f204 as the first sub-frame.

The difference processing unit 107 generates and outputs the sub-frame f205 as the second sub-frame on the basis of the sub-frame f204 and the frame f201 held in the frame memory 102. The switch 108 alternately switches and outputs the sub-frame f204 and the sub-frame f205.

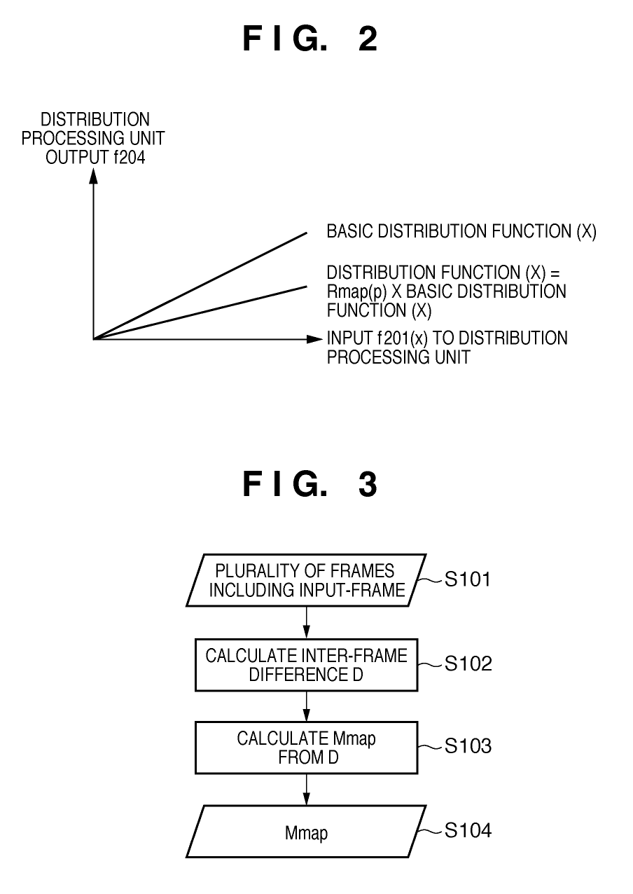

FIG. 2 is a view showing an example of an input/output relationship in the distribution processing unit 106. The distribution processing unit 106 converts each value of the input f201 to the distribution processing unit 106 in accordance with the basic distribution function and the distribution correction coefficient map Rₘₐₚ, and outputs the result as the sub-frame f204 (see equation (1)). The basic distribution function indicates the value of the sub-frame f204 when the input is a still image (at the time of still image capturing).

S(p)=basic distribution function(fin(p))×Rmap(p) (1)

where fin is an input frame, S is an output frame, and p is the position of a pixel of interest.

The value of each region in the sub-frame f204 dynamically increases/decreases in accordance with the value of the distribution correction coefficient map Rₘₐₚ. For example, as the value of a distribution correction coefficient R for a region with a large amount of motion decreases, the value of a corresponding region in the sub-frame f204 decreases. With this operation, since the value of a region with a large amount of motion in a sub-frame output as a temporally succeeding sub-frame in one frame period decreases, the pseudo-contour and trailing-blur are improved.

FIG. 3 is a flowchart showing an example of processing in the motion region detection unit 103.

The motion region detection unit 103 calculates an inter-frame difference from an input-frame and a frame input before (e.g., immediately before) the input-frame (steps S101 and S102). The motion region detection unit 103 calculates and outputs the degree M of motion from the difference value (steps S103 and S104). The degree M of motion is output as Mₘₐₚ in the form of a map (two-dimensional map) having a degree of motion for each region. This embodiment will exemplify a case in which a region is a single pixel. However, a region may be a predetermined range of a plurality of pixels (N×N pixels). If a plurality of pixels constitute a region, the region can be processed by the same processing as that for the region formed by a single pixel by processing the average value or the like of the plurality of pixels as the region.

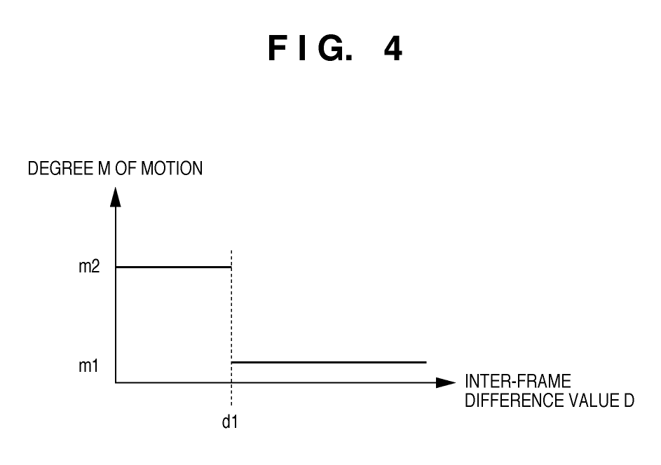

FIG. 4 is a graph showing an example of the relationship between an inter-frame difference value D and the degree M of motion. As shown in FIG. 4, as the inter-frame difference value D increases, the detected degree M of motion tends to decrease. That is, in this embodiment, since the degree M of motion indicates the degree of stillness, the degree M of motion is high in a region with a small amount of motion and low in a region with a large amount of motion. Although this embodiment will be described by referring to a case in which the degree M of motion indicates the degree of stillness, it is obvious that the embodiment can be applied to a case opposite to the above case.

The motion region detection unit 103 calculates the degree of motion of each region in the frame f201 held in the frame memory 102 by executing threshold processing with a relatively low processing load. More specifically, if the inter-frame difference value is smaller than a (predetermined) threshold d1, the motion region detection unit 103 outputs m2 as a degree of motion. If the inter-frame difference value is larger than the threshold d1, the motion region detection unit 103 outputs m1 as a degree of motion. This threshold processing is performed for each inter-frame difference value calculated in accordance with each region. As a result, Mₘₐₚ in the form of a map is output as a degree of motion. Note that m1 and m2 are, for example, greater than or equal to 0 and less than or equal to 1, and m2 is larger than m1.

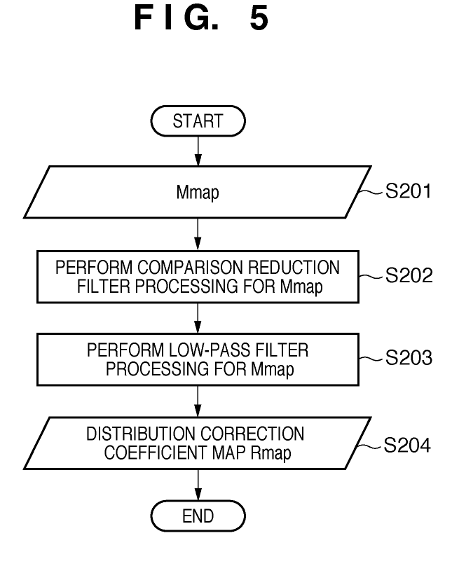

FIG. 5 is a flowchart showing an example of processing in the distribution correction coefficient generating unit 104.

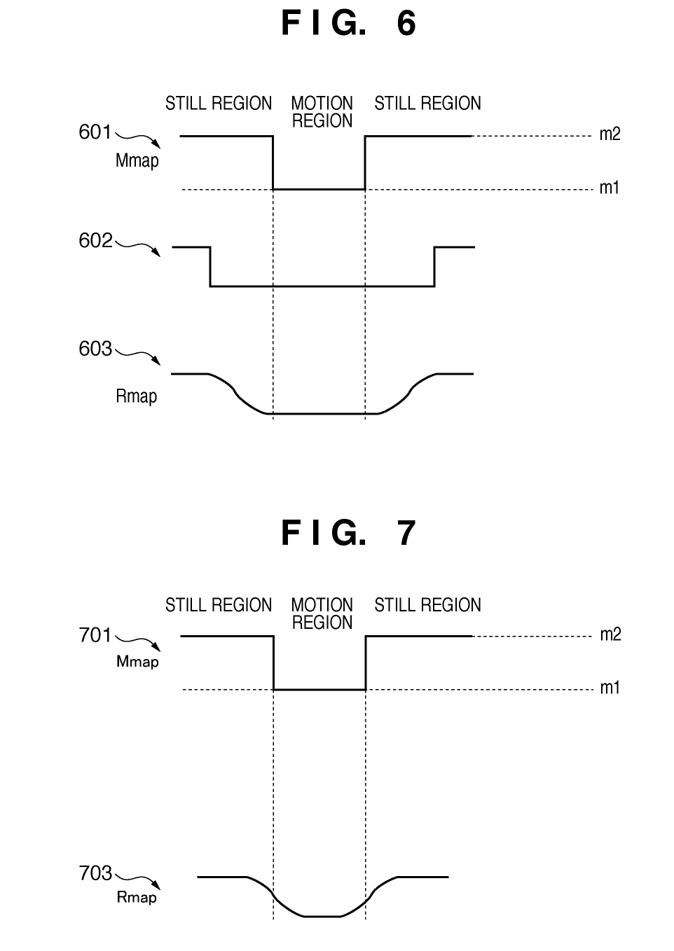

This processing starts when the degree-of-motion map Mₘₐₚ is input to the distribution correction coefficient generating unit 104 (step S201). In this case, as indicated by “601” in FIG. 6, according to the degree-of-motion map Mₘₐₚ, m2 is given as a degree of motion to a region determined as a still region, and m1 is given as a degree of motion to a region determined as a motion region. Note that the abscissa represents the pixel position.

First of all, the distribution correction coefficient generating unit 104 performs comparison reduction filter processing for the degree-of-motion map Mₘₐₚ (step S202). In this processing, the distribution correction coefficient generating unit 104 compares the value of the degree M of motion of a region of interest with the value of the degree M of motion of a neighboring region (a region of a predetermined range) to reduce the value of the degree M of motion of the region of interest. The filter has, for example, a characteristic that replaces a given value with the minimum value in the filter range. In the degree-of-motion map Mₘₐₚ, as indicated by “602” in FIG. 6, the value of the degree M of motion of a still region is reduced.

Subsequently, the distribution correction coefficient generating unit 104 executes low-pass filter processing for the result of the comparison reduction filter processing (step S203), and then outputs the processing result as the distribution correction coefficient map Rₘₐₚ to the distribution processing unit 106 (step S204). As indicated by “603” in FIG. 6, in the distribution correction coefficient map Rₘₐₚ to be output, signals in the high frequency region are removed by low-pass filter processing. As a result, a spatially smooth value is obtained. As indicated by “603” in FIG. 6, if a still region is adjacent to a motion region, the value of the distribution correction coefficient R in a predetermined range up to a boundary position where the still region contacts the motion region is continuously attenuated.

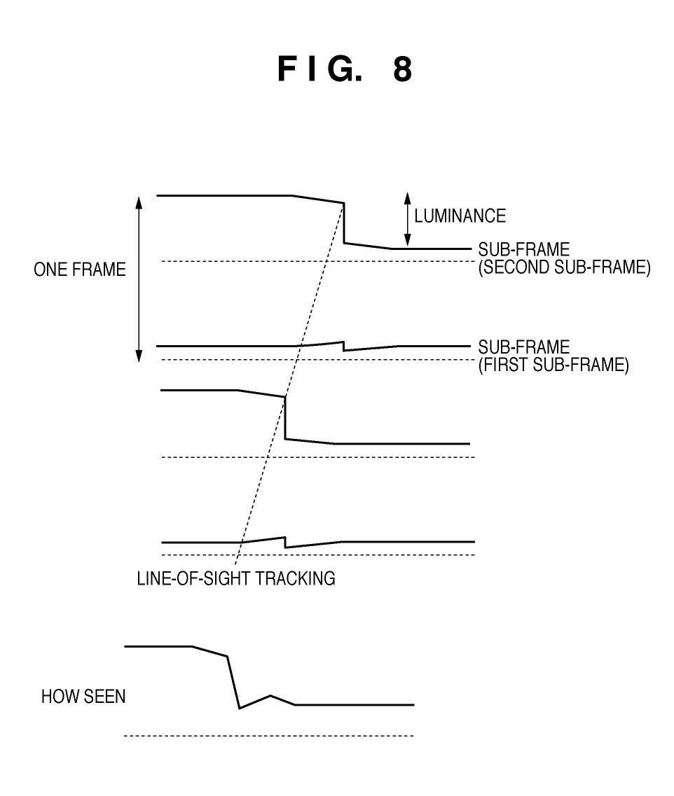

As described above, the distribution correction coefficient generating unit 104 in this embodiment changes the distribution correction coefficient R for each region in a frame. In this changing operation, the distribution correction coefficient generating unit 104 smoothly changes the distribution correction coefficient R spatially by smoothing the degree-of-motion map Mₘₐₚ by low-pass filter processing. The reason that comparison reduction filter processing is performed before low-pass filter processing in this case is that if the distribution correction coefficient map Rₘₐₚ is generated without comparison reduction filter processing, the value of an end portion of the motion region in a sub-frame increases as shown in FIG. 7. In this case, as shown in FIG. 8, an image collapses at the boundary between the still region and the motion region. It is preferable to smooth the distribution correction coefficient R only in the still region without performing it in the motion region.

The difference processing unit 107 outputs, as the sub-frame f205, the result obtained by calculating the difference between the frame f201 held in the frame memory 102 and the sub-frame f204. The sum of sub-frames to be output therefore matches the frame held in the frame memory 102. In the case of an impulse type display apparatus, if the sums of signals displayed within an arbitrary time are equal, the apparent brightnesses look almost equal. It is therefore possible to keep the brightness of a frame before and after frame rate conversion almost equal.

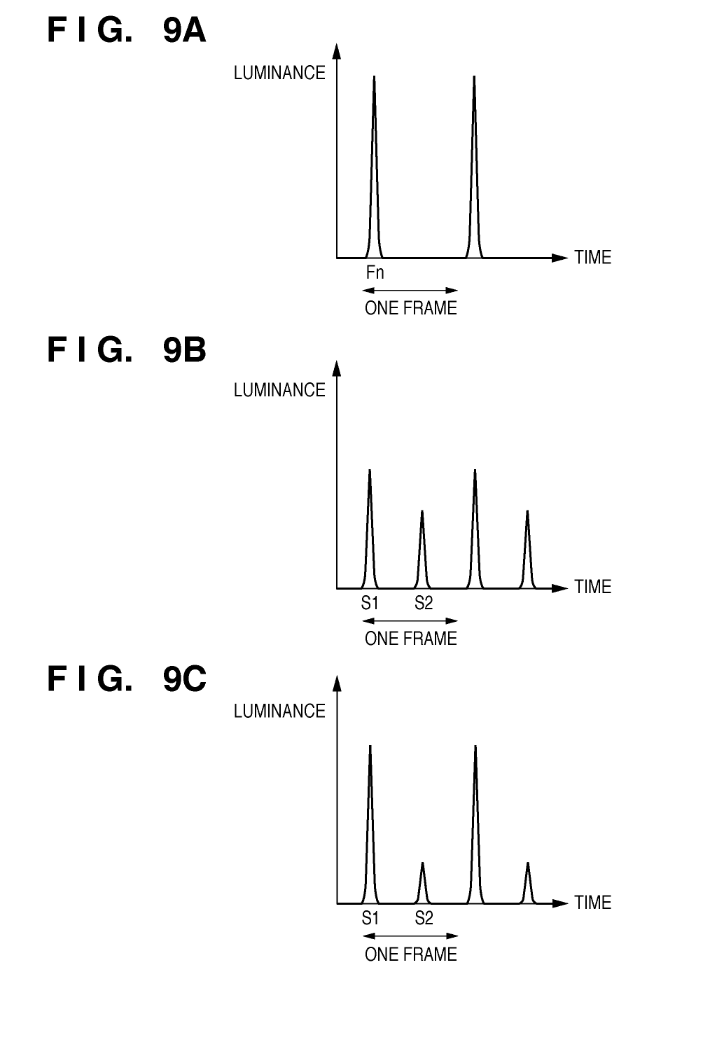

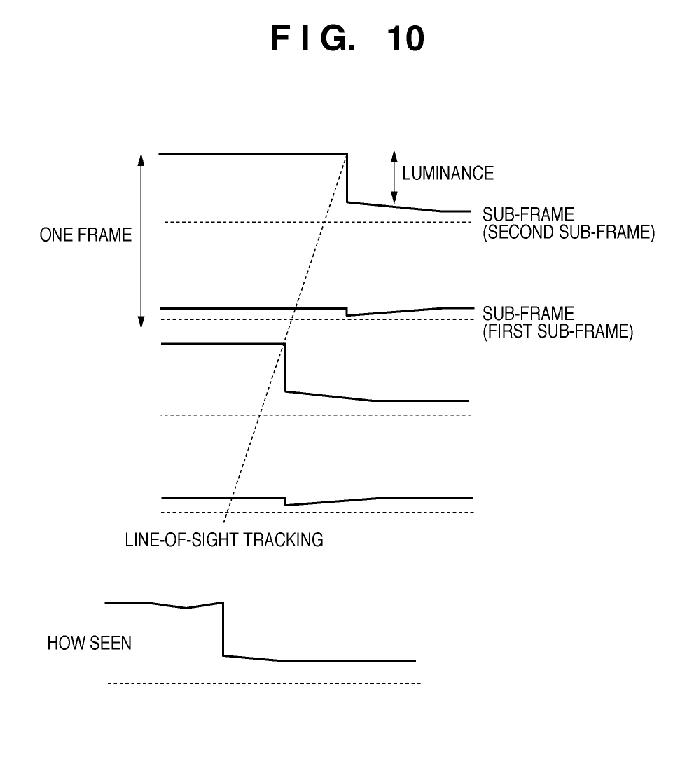

In this case, FIG. 9A shows the frame f201 held in the frame memory 102, and FIGS. 9B and 9C show outputs when the distribution correction coefficient map Rₘₐₚ changes.

As described above, the distribution correction coefficient R corresponding to a region with a small amount of motion is set to a large value. For this reason, in the sub-frame f204 output as a temporally succeeding sub-frame in one frame period, the amount of distribution of an output value corresponding to the region increases. The waveform shown in FIG. 9B indicates the luminance of each sub-frame in this region in this case. Although flicker tends to occur in a region with a small amount of motion, since the value of this region in the sub-frame f204 is ensured by a level at which flicker can be reduced, the occurrence of flicker can be prevented.

In contrast, as described above, the distribution correction coefficient R corresponding to a region with a large amount of motion is set to a small value. For this reason, in the sub-frame f204 output as a temporally succeeding sub-frame in one frame period, the amount of distribution of an output value corresponding to the region decreases. The waveform shown in FIG. 9C indicates the luminance of each sub-frame in this region in this case. Since flicker is not easily detected in a region with a large amount of motion, even if the value of this region in the sub-frame f204 is small, the possibility of the occurrence of flicker is low.

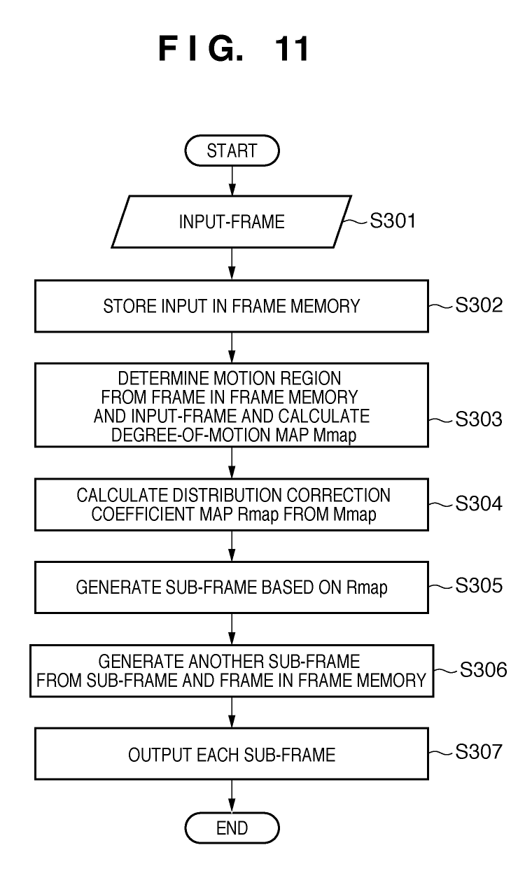

In this case, for example, the relationship shown in FIG. 10 indicates an outline of a display output in a case in which the luminance of each sub-frame is represented by the waveform shown in FIG. 9C and the manner of how the display output is visually perceived. The relationship between an outline of the display output and the manner of how the display output is seen, which is shown in FIG. 10, reveals that pseudo-contour and image collapse are reduced as compared with the case shown in FIG. 8.

A processing sequence in the frame rate conversion apparatus shown in FIG. 1 will be described next with reference to FIG. 11.

Upon receiving the input-frame f200 (step S301), the frame rate conversion apparatus stores the frame in the frame memory 102 (step S302). Upon completion of storage of this frame, the frame rate conversion apparatus causes the motion region detection unit 103 to compare the input-frame f200 with the frame which has already been stored in the frame memory 102. The frame rate conversion apparatus then calculates the degree M of motion for each region in the frame f201 stored in the frame memory 102 and outputs the degree-of-motion map Mₘₐₚ (step S303).

Subsequently, the frame rate conversion apparatus causes the distribution correction coefficient generating unit 104 to execute filter processing for the calculated degree-of-motion map Mₘₐₚ to calculate the result as the distribution correction coefficient map Rₘₐₚ (step S304). The frame rate conversion apparatus causes the distribution processing unit 106 to convert the value of the frame f201, which has already been stored in the frame memory 102, in accordance with the basic distribution function and the distribution correction coefficient map Rₘₐₚ and generates the sub-frame f204 (step S305).

Upon completing generation of the sub-frame f204, the frame rate conversion apparatus causes the difference processing unit 107 to generate the sub-frame f205 from the difference between the frame f201 which has already been stored in the frame memory 102 and the sub-frame f204 (step S306). The frame rate conversion apparatus then causes the switch 108 to alternately switch and output the sub-frame f204 and the sub-frame f205 (step S307). Subsequently, every time an input-frame is input, the above processing is repeatedly executed.

As described above, according to this embodiment, a degree of motion is detected from each region of an image in a frame, and the amounts of distribution of the respective regions in the sub-frames f204 and f205 are determined in accordance with the detection result. This makes it possible to reduce pseudo-contour and image collapse while maintaining the effect of reducing flicker.

The above is a typical embodiment of the present invention. However, the present invention is not limited to the above embodiment shown in the accompanying drawings and can be modified and executed as needed within the scope of the present invention.

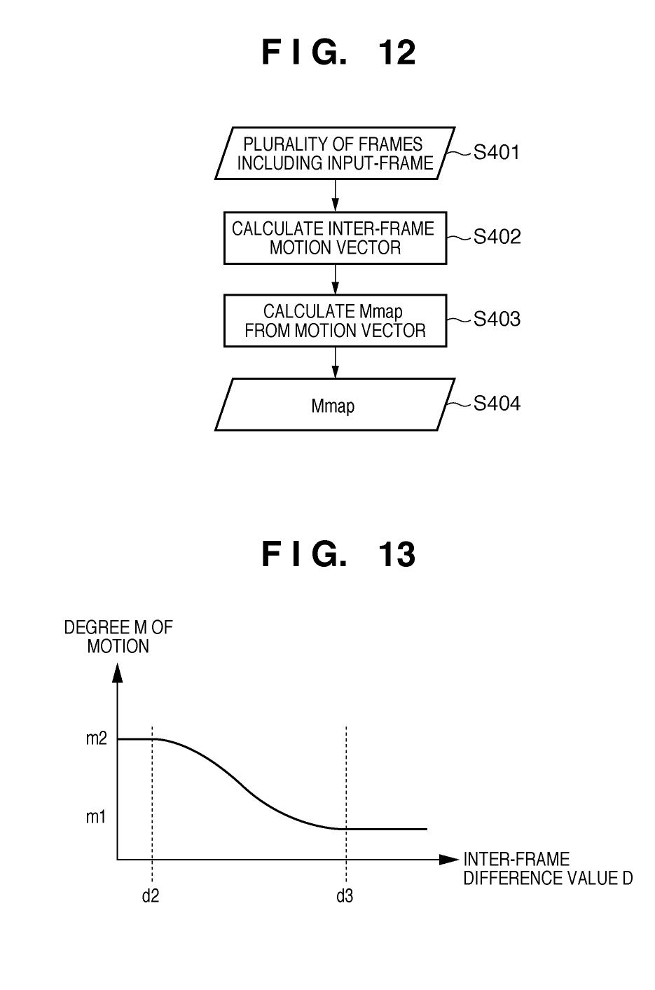

For example, the above embodiment has exemplified the case in which an inter-frame difference value is obtained, and the degree M of motion of each region in an image of a frame is calculated from the relationship between the difference value and a threshold. However, the present invention is not limited to this. For example, it suffices to calculate the vector of each region between frames and calculate the degree M of motion from the magnitude of the vector. A processing sequence in the motion region detection unit 103 in this case will be described with reference to FIG. 12. The motion region detection unit 103 calculates an inter-frame motion vector from an input-frame and a frame input before (for example, immediately before) the input-frame (steps S401 and S402). The motion region detection unit 103 then calculates and outputs the degree M of motion from the motion vector (steps S403 and S404). Note that it suffices to calculate the degree M of motion on the basis of the magnitude of the motion vector by the same method as that described with reference to FIG. 4. Using a motion vector makes it possible to recognize the magnitude of the motion of each region in an image of a frame more accurately.

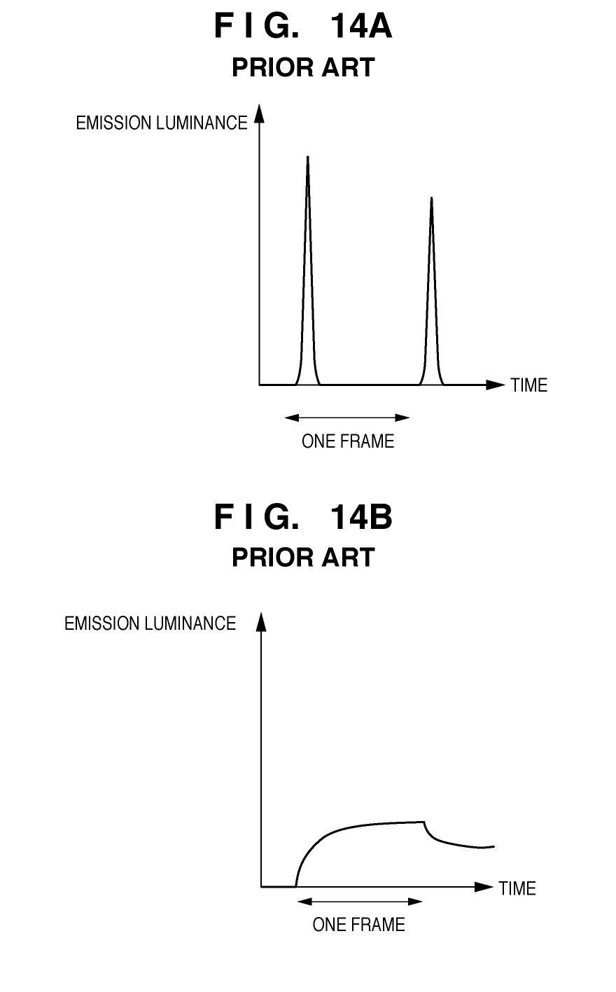

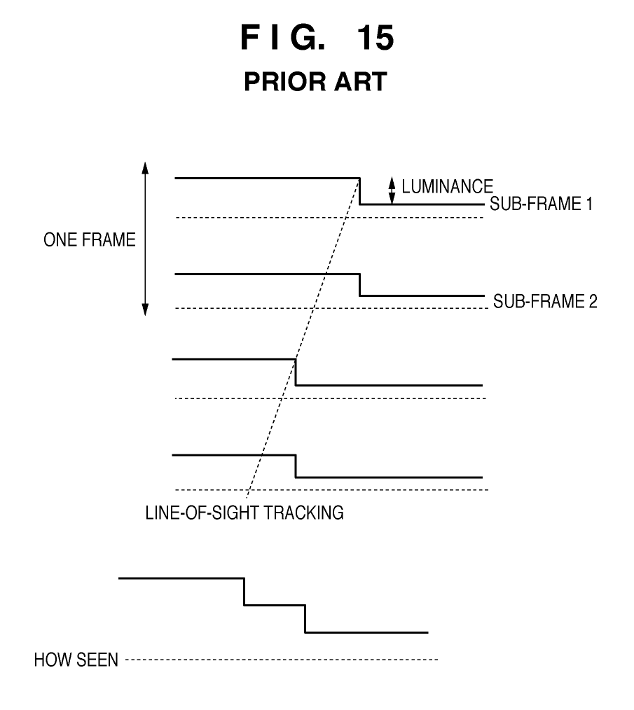

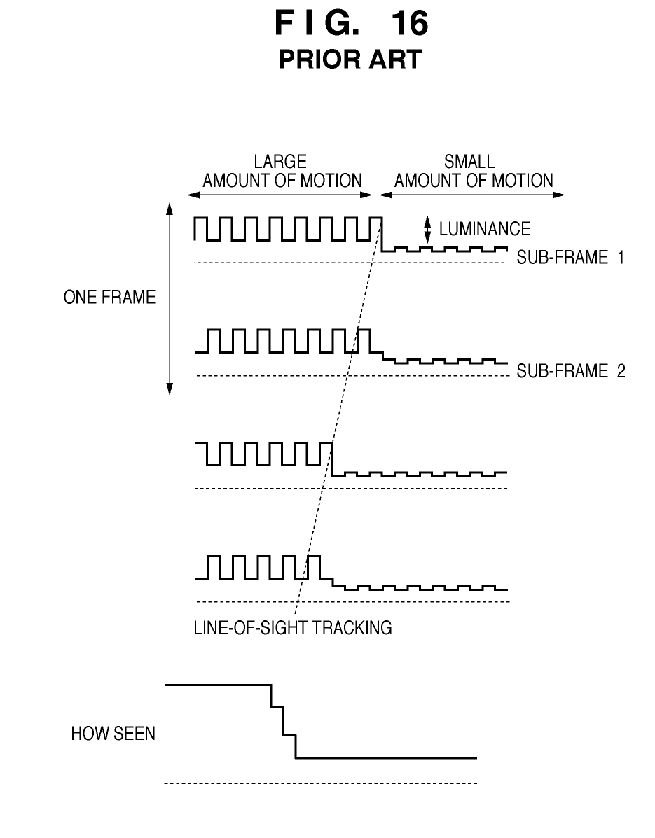

The above embodiment has exemplified the case in which the degree M of motion is a binary value (m1, m2). However, the present invention is not limited to this. For example, as shown in FIG. 13, it suffices to output m2 if the inter-frame difference value D is less than or equal to a threshold d2 as the first value and to output m1 if the inter-frame difference value D is larger than a threshold d3 as the second value. If the inter-frame difference value D is between d2 and d3, a value between m2 and m1 is output as the degree M of motion (in this case, the degree M of motion indicates the degree of stillness). In this case, if the inter-frame difference value D is between d2 and d3, the value of the degree M of motion to be output monotonously changes (decreases) with an increase in the difference value. This reflects the continuity of the magnitude of the motion. Obviously, even when the degree M of motion is obtained from the above motion vector, the degree M of motion can be obtained by using this method.

The present invention can adopt embodiments in the forms of, for example, a system, apparatus, method, program, and storage medium. The present invention may be applied to either a system constituted by a plurality of devices, or an apparatus consisting of a single device.

The present invention includes a case wherein the functions of the aforementioned embodiments are achieved when a software program is directly or remotely supplied to a system or apparatus, and a computer incorporated in that system or apparatus reads out and executes the supplied program codes. The program to be supplied in this case is a computer program corresponding to the illustrated flowcharts in the embodiments.

Therefore, the program codes themselves installed in a computer to implement the functional processing of the present invention using the computer also implement the present invention. That is, the present invention includes the computer program itself for implementing the functional processing of the present invention. In this case, the form of program is not particularly limited, and an object code, a program to be executed by an interpreter, script data to be supplied to an OS (Operating System), and the like may be used as long as they have the functions of the program.

As a computer-readable storage medium for supplying the computer program, the following media can be used. As another program supply method, the user establishes connection to a website on the Internet using a browser on a client computer, and downloads the computer program of the present invention from the website onto a recording medium such as a hard disk.

The functions of the aforementioned embodiments can be implemented when the computer executes the readout program. In addition, the functions of the aforementioned embodiments may be implemented in collaboration with an OS or the like running on the computer based on an instruction of that program. In this case, the OS or the like executes some or all of actual processes, which implement the functions of the aforementioned embodiments.

As has been described above, according to the present invention, it is possible to suppress pseudo-contour and image collapse while maintaining the effect of reducing flicker.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-119988 filed on May 1, 2008, which is hereby incorporated by reference herein in its entirety.

What is claimed is:

1. A frame rate conversion apparatus for performing frame rate conversion upon distributing an input-frame into a plurality of sub-frames, the apparatus comprising:
a detection unit configured to detect a degree of motion of each region including at least one pixel in the input-frame;
a determination unit configured to determine an amount of distribution of an output value in each region in the plurality of sub-frames in accordance with the degree of motion of each region detected by the detection unit; and
an output unit configured to output the plurality of sub-frames to which output values are distributed in accordance with the amount of distribution determined by the determination unit.

2. The apparatus according to claim 1, wherein
the determination unit determines the amount of distribution by generating a distribution correction coefficient for correcting the amount of distribution in each region in the plurality of sub-frames in accordance with the degree of motion of each of the regions, and
the output unit comprises
a distribution processing unit configured to distribute an output value of each region of the input-frame to a first sub-frame in accordance with the amount of distribution corrected by the distribution correction coefficient generated by the determination unit,
a difference processing unit configured to generate a second sub-frame from a difference between the first sub-frame and the input-frame, and
a switching unit configured to switch between the first sub-frame and the second sub-frame in one frame period, and output the sub-frame.

3. The apparatus according to claim 1, wherein the detection unit calculates an inter-frame difference value in accordance with the input-frame and a frame input before the input-frame, and detects a degree of motion of each region of an image in the frame input before the input-frame in accordance with a relationship between the calculated difference value and a threshold.

4. The apparatus according to claim 1, wherein the detection unit calculates a motion vector of each region between frames in accordance with the input-frame and a frame input before the input-frame, and detects a degree of motion of each region of an image in the frame input before the input-frame in accordance with the calculated motion vector.

5. The apparatus according to claim 1, wherein
the detection unit detects degrees of motion corresponding to a region with a large amount of motion and a region with a small amount of motion in accordance with a relationship between a motion of each region of an image of a frame input before the input-frame and a predetermined value, and
the determination unit, in the case of the region with a large amount of motion, sets the amount of distribution for the region corresponding to a temporally succeeding sub-frame to be smaller than the amount of distribution for the same region of the sub-frame in a case when the region has a small amount of motion.

6. The apparatus according to claim 1, wherein
the detection unit detects degrees of motion corresponding to a region with a large amount of motion and a region with a small amount of motion in accordance with a relationship between a motion of each region of an image of a frame input before the input-frame and a predetermined value, and
the determination unit, in the case of the region with a small amount of motion, sets the amount of distribution for the region corresponding to a temporally succeeding sub-frame to be larger than the amount of distribution for the same region of the sub-frame in a case when the region has a large amount of motion.

7. The apparatus according to claim 1, wherein
a first value and a second value larger than the first value are set in advance,
the detection unit detects degrees of motion corresponding to regions including a region with a large amount of motion and a region with a small amount of motion in accordance with a relationship between a motion of each region of an image in a frame input before the input-frame and one of the first value and the second value, and
the determination unit, in the case of the region with a large amount of motion, sets the amount of distribution for the region corresponding to a temporally succeeding sub-frame to be smaller than the amount of distribution for the same region of the sub-frame in a case when the region has a small amount of motion, in the case of the region with a small amount of motion, sets the amount of distribution for the region corresponding to a temporally succeeding sub-frame to be larger than the amount of distribution for the same region of the sub-frame in a case when the region has a large amount of motion.

8. The apparatus according to claim 7, wherein
the detection unit, if a motion of a region of an image in a frame input before the input-frame is between the first value and the second value, detects the degree of motion corresponding to the region in accordance with the motion of the region and a degree of motion that monotonously changes between the first value and the second value, and
the determination unit, if the motion of the region is between the first value and the second value, sets the amount of distribution for the region corresponding to a temporally succeeding sub-frame to be smaller than the amount of distribution for the same region of the sub-frame in a case when the region has a small amount of motion,
wherein the amount of distribution set by the determination unit, if the motion of the region is between the first value and the second value, continuously changes in accordance with the detected degree of motion.

9. The apparatus according to claim 6, wherein for the region with the small amount of motion which is adjacent to the region with the large amount of motion, the determination unit sets the amount of distribution for the region corresponding to a temporally succeeding sub-frame so as to continuously decrease an amount of distribution in a predetermined range in the region with the small amount of motion up to a boundary position where the region with the small amount of motion contacts the region with the large amount of motion.

10. A frame rate conversion method for performing frame rate conversion upon distributing an input-frame into a plurality of sub-frames, the method comprising:
detecting a degree of motion of each region including one pixel or a plurality of pixels in the input-frame;
determining an amount of distribution of an output value in each region in the plurality of sub-frames in accordance with the detected degree of motion of each region; and
outputting the plurality of sub-frames to which output values are distributed in accordance with the determined amount of distribution.

11. A computer-readable storage medium storing a computer program of causing a computer incorporated in a frame rate conversion apparatus for performing frame rate conversion upon distributing an input-frame into a plurality of sub-frames to function as
a detection unit configured to detect a degree of motion of each region including one pixel or a plurality of pixels in the input-frame,
a determination unit configured to determine an amount of distribution of an output value in each region in the plurality of sub-frames in accordance with the degree of motion of each region detected by the detection unit, and
an output unit configured to output the plurality of sub-frames to which output values are distributed in accordance with the amount of distribution determined by the determination unit.
